(19) United States
(12) Patent Application Publication
(10) Pub. No.: US 2007/0138451 A1
(43) Pub. Date: Jun. 21, 2007

(54) LIFTING APPARATUS FOR PROJECTING SYSTEM

(76) Inventor: Yi-Ting Hsu, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/610,103

(22) Filed: Dec. 13, 2006

(30) Foreign Application Priority Data
Dec. 16, 2005 (TW) 094144681

(51) Int. Cl. B66F 7/26

(52) U.S. Cl. 254/45; 74/640; 254/95; 248/413

(57) ABSTRACT

The invention provides a lifting apparatus for a projecting system. The lifting apparatus according to the invention includes an adjustable lifting device and a controlling device. The adjustable lifting device is used for moving a housing of the projecting system. The controlling device is coupled to the adjustable lifting device, and used for accessing, responsive to a request signal, a height datum to control the adjustable lifting device to move the housing of the projecting system in accordance with the accessed height datum.

### BACKGROUND OF THE INVENTION

1. Field of the Invention

This present invention relates to a lifting apparatus for a projecting system and, more particularly, to a lifting apparatus with capability of automatically lifting or lowering a projecting system equipped with the lifting apparatus.

2. Description of the Prior Art

Recently, projecting systems, such as liquid crystal projector, liquid crystal projection television, etc. have become more and more popular. In practical application, it is necessary to adjust the height and angle of the projecting system so that the image projected by the projecting system is then imaged on the right position. Therefore, the projecting system is usually equipped with a lifting apparatus, so as to be moved up or down for adjustment.

Presently, the projection height and angle of the projecting system is designed to be adjusted manually, so it is inconvenient for a user to adjust the projection height and angle of the projecting system. Especially, it becomes more inconvenient for a user to adjust its height and angle, if the projecting system is a large-scale one with large volume and heavy weight. Hence, the user usually has to spend a lot of time in adjusting and positioning the projecting system.

Accordingly, a scope of the invention is to provide a lifting apparatus capable of automatically lifting or lowering the projecting system, so as to solve the aforementioned problems.

### SUMMARY OF THE INVENTION

A scope of the invention is to provide a lifting apparatus for a projecting system. The lifting apparatus is controlled through a remote control or a console to adjust the height of the projecting system automatically. This lifting apparatus makes it more convenient and comfortable for a user to adjust the projecting system to an appropriate position.

A lifting apparatus, according to the first preferred embodiment of the invention, includes an adjustable lifting device and a controlling device. The adjustable lifting device is used for assisting a projecting system in placing on a plane, and for adjusting the projection height of the projecting system relative to the plane. The controlling device is coupled to the adjustable lifting device. The controlling device is used for controlling, in response to a request signal, the adjustable lifting device to move the projecting system to a height relative to the plane.

A lifting apparatus, according to the second preferred embodiment of the invention, includes a lifting device, a storing device and a controlling device. The adjustable lifting device is used for assisting the projecting system in placing on the plane. The storing device is used for storing at least one height datum associated with the projecting system. The controlling device is coupled to the adjustable lifting device and the storing device, respectively. The controlling device is used for accessing one of the stored height data stored in the storing device in response to a request signal. The controlling device controls the adjustable lifting device to move the housing of the projecting system to a height relative to the plane in accordance with the accessed height datum.

Therefore, the lifting apparatus according to the invention, used for a projecting system, is used to adjust the height of the projecting system automatically to an appropriate height. Furthermore, the lifting apparatus according to the invention uses the storing device to store height data associated with the projecting system, and adjusts the projecting system automatically to an appropriate height according to one of the stored height data. The use of the lifting apparatus not only makes it more convenient for a user to adjust the height of the projecting system, but also requires less time in adjusting the height of the projecting system because the most suitable height can be recorded.

The advantage and spirit of the invention may be understood by the following recitations together with the appended drawings.

### BRIEF DESCRIPTION OF THE APPENDED DRAWINGS

FIG. 1 is an outside view of the lifting apparatus according to the invention, and it also shows a projecting system on which the lifting apparatus performs.

FIG. 2 is a schematic drawing illustrating the operation of the lifting apparatus shown in FIG. 1.

FIG. 3 is an outside view of the adjustable lifting device according to the invention.

### DETAILED DESCRIPTION OF THE INVENTION

A lifting apparatus, according to the first preferred embodiment of the invention, includes an adjustable lifting device and a controlling device. In practice, the lifting apparatus is installed on a projecting system including a housing. In usual, the projecting system is placed on a plane. The adjustable lifting device is used for moving the housing of the projecting system to a user-preferable position relative to the plane. The controlling device is coupled to the adjustable lifting device. The controlling device is used for controlling, in response to a request signal, the adjustable lifting device to move the housing of the projecting system to a height relative to the plane.

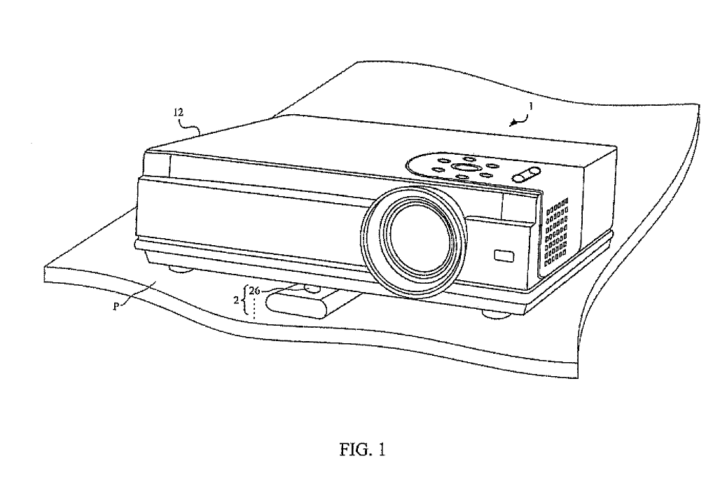

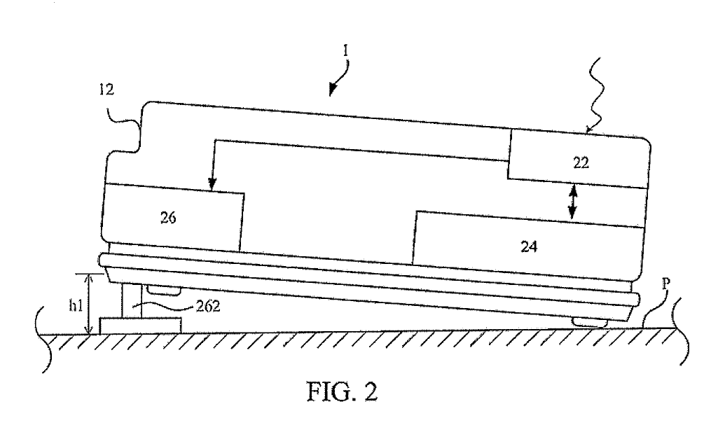

Referring to FIG. 1 and FIG. 2, FIG. 1 is an outside view of the lifting apparatus 2 according to the second preferred embodiment of the invention, and it also shows a projecting system 1 on which the lifting apparatus 2 is installed. FIG. 2 is a schematic drawing illustrating the operation of the lifting apparatus 2 in FIG. 1. As shown in FIG. 1, the projecting system 1 is placed on a plane P, and includes a housing 12.

As shown in FIG. 2, the lifting apparatus 2, according to the second preferred embodiment of the invention, includes an adjustable lifting device 26, a storing device 24, and a controlling device 22. The adjustable lifting device 26 is used for lifting the housing 12 of the projecting system 1 relative to the plane P. The storing device 24 is used for storing at least one first height datum associated with the projecting system 1. The controlling device 22 is coupled to the adjustable lifting device 26 and the storing device 24, respectively. The controlling device 22 accesses one of the at least one first height datum stored in the storing device 24 in response to a first request signal. In practice, the first request signal is generated in response to a first request command, such as a user's input, or in response to the power-on of the projecting system 1. The controlling device 22 controls the adjustable lifting device 26 to move the housing 12 of the projecting system 1 to a height h1 relative to the plane P in accordance with the accessed first height datum.

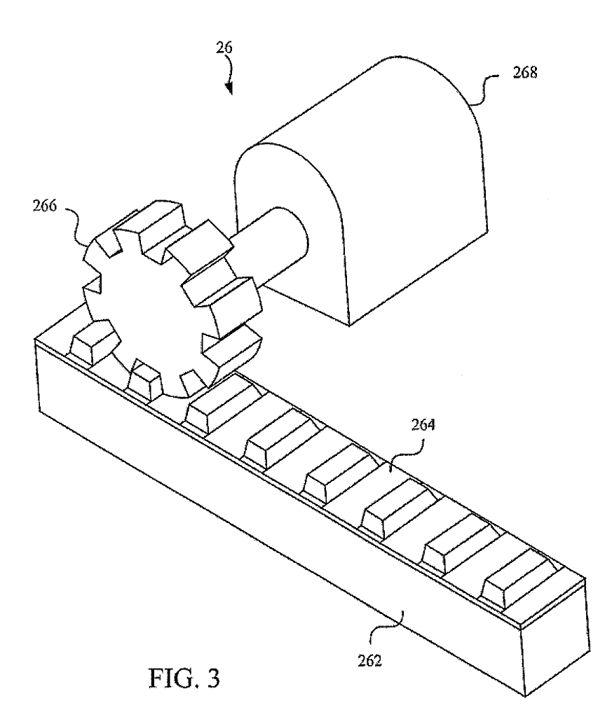

Referring to FIG. 3, FIG. 3 is an outside view of the adjustable lifting device 26 according to the second preferred embodiment of the invention. As shown in FIG. 3, the adjustable lifting device 26 includes a support shaft 262, a rack 264, a gear module 266, and a motor 268. In a practical application, the motor is a stepper motor.

The support shaft 262 has a first end and a second end. The first end of the support shaft 262 is disposed inside the housing 12 of the projecting system 1. The second end of the support shaft 262 protrudes outside the housing 12 to contact the plane on which the projecting system 1 is placed. The rack 264 is mounted on the support shaft 262. The gear module 266 is mounted inside the housing 12 and is meshed with the rack 264. The motor 268 is mounted inside the housing 12. The motor 268 is coupled to the controlling device 22, and operatively connected to the gear module 266. The motor 268 is controlled by the controlling device 22 to drive the gear module 266 rotating. In the second preferred embodiment, the lifting and lowering of the projecting system 1 relative to the plane is done by utilizing the motor 268 to drive the gear module 266 rotating, so as to move along the rack 264.

In another preferred embodiment, the adjustable lifting device 26 further includes a skid-proof part (not shown in the appended drawings) attached on the second end of the support shaft 262.

In another preferred embodiment, the lifting apparatus 2 further includes a detecting device (not shown in the appended drawings). The detecting device is used for detecting, in response to a second request signal, the height of the housing 12 of the projecting system 1 relative to the plane P. The detecting device, for example, measures the height from the motor 268 to the second end of the support shaft 262, generates a second height datum associated with the detected height, and stores the second height datum into the storing device 24. In one practical application, the second request signal is generated in response to the power-off of the projecting system 1.

In one practical application, the projecting system can be a projector. The controlling device is implemented into a form of a circuit board, and coupled to the adjustable lifting device and the storing device, respectively. The user can control the adjustable lifting device to adjust the height of the projector relative to the plane by operating the controlling device through an interface. The interface can be implemented into a remote control component or a console mounted on the projector. The user can use a remote control to transmit a signal to the controlling device, so as to adjust the height of the projector relative to the plane, and also to detect and store the present height datum associated with of the projector. Furthermore, the projector with the lifting apparatus according to the invention can generate a first request signal when the power of the projector is turned on, thus trigger the controlling device to read an appropriate height datum stored in the storing device; then, the projector will be automatically adjusted its height to an position corresponding to the read height datum. When the power of the projector is to be turned off, the projector generates a second request signal in response to the power-off of the projector; this triggers the controlling device to record the present height datum and to read an original height datum stored in the storing device, so as to adjust its height automatically back to an original position in accordance with the original height datum.

Compared to the prior art, the lifting apparatus according to the invention allows the user to adjust the height of the projecting system relative to the plane automatically. Therefore, it is no longer necessary for the user to lift or lower the projecting system manually for the adjustment. In addition, the lifting apparatus according to the invention further uses a storing device to record the height data associated with the projecting system, so as to save the user's time in adjusting the height of the projecting system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A lifting apparatus for a projecting system, the projecting system comprising a housing, said lifting apparatus comprising:
an adjustable lifting device, for moving the housing of the projecting system; and
a controlling device, coupling to the adjustable lifting device, for accessing, responsive to a first request signal, a first height datum to control the adjustable lifting device to move the housing of the projecting system to a first height corresponding to the first height datum.

2. The lifting apparatus of claim 1, further comprising a storing device, coupled to the controlling device, for storing the first height.

3. The lifting apparatus of claim 2, wherein the adjustable lifting device comprises:
a support shaft having a first end disposed inside the housing of the projecting system and a second end protruding outside the housing to contact a plane when the projecting system is placed on the plane;
a rack mounted on the support shaft;
a gear module mounted inside the housing and disposed so as to mesh with the rack; and
a motor, mounted inside the housing, coupled to the controlling device and operatively connected to the gear module, the motor being controlled by the controlling device to drive the gear module rotating;
wherein lifting and lowering of the projecting system relative to the plane is done by utilizing the motor to drive the gear module rotating so as to move along the rack.

4. The lifting apparatus of claim 3, wherein the adjustable lifting device further comprises a skid-proof part attached on the second end of the support shaft.

5. The lifting apparatus of claim 3, wherein the motor is a stepper motor.

6. The lifting apparatus of claim 2, wherein the first request signal is generated in response to the power-on of the projecting system.

7. The lifting apparatus of claim 2, wherein the first request signal is generated in response to a first input command.

8. The lifting apparatus of claim 3, further comprising a detecting device for detecting, responsive to a second request signal, the height of the housing relative to the plane, generating a second height datum associated with the projecting system in accordance with the detected height, and storing the second height datum into the storing device.

9. The lifting apparatus of claim 8, wherein the second request signal is generated in response to the power-off of the projecting system.

10. The lifting apparatus of claim 8, wherein the second request signal is generated in response to a second input command.

11. A lifting apparatus for a projecting system placed on a plane, the projecting system comprising a housing, said lifting apparatus comprising:
an adjustable lifting device, for assisting the housing of the projecting system in placing on the plane, and the adjustable lifting device being capable of moving the housing of the projecting system relative to the plane; and
a controlling device, coupled to the adjustable lifting device, for controlling, responsive to a request signal, the adjustable lifting device to move the housing of the projecting system to a height relative to the plane.

12. The lifting apparatus of claim 11, wherein the adjustable lifting device comprises:
a support shaft having a first end disposed inside the housing of the projecting system and a second end protruding outside the housing to contact the plane when the projecting system is placed on the plane;
a rack mounted on the support shaft;
a gear module mounted inside the housing and disposed so as to mesh with the rack; and
a motor, mounted inside the housing, coupled to the controlling device and operatively connected to the gear module, the motor being controlled by the controlling device to drive the gear module rotating;
wherein lifting and lowering of the projecting system relative to the plane is done by utilizing the motor to drive the gear module rotating so as to move along the rack.

13. The lifting apparatus of claim 12, wherein the adjustable lifting device further comprises a skid-proof part attached on the second end of the support shaft.

14. The lifting apparatus of claim 12, wherein the motor is a stepper motor.

15. A projecting system, comprising:
a housing;
an adjustable lifting device for assisting the housing of the projecting system in placing on the plane, and the adjustable lifting device being capable of moving the housing of the projecting system relative to the plane;
a storing device, for storing at least one first height datum associated with the projecting system; and
a controlling device, coupled to the adjustable lifting device and the storing device, respectively, for accessing one from the at least one first height datum stored in the storing device in response to a first request signal, and controlling the adjustable lifting device to move the housing of the projecting system to a height relative to the plane in accordance with the accessed first height datum.

16. The projecting system of claim 15, wherein the adjustable lifting device comprises:
a support shaft having a first end disposed inside the housing of the projecting system and a second end protruding outside the housing to contact the plane when the projecting system is placed on the plane;
a rack mounted on the support shaft;
a gear module mounted inside the housing and disposed so as to mesh with the rack; and
a motor, mounted inside the housing, coupled to the controlling device and operatively connected to the gear module, the motor being controlled by the controlling device to drive the gear module rotating;
wherein lifting and lowering of the projecting system relative to the plane is done by utilizing the motor to drive the gear module rotating so as to move along the rack.

17. The projecting system of claim 16, wherein the adjustable lifting device further comprises a skid-proof part attached on the second end of the support shaft.

18. The projecting system of claim 16, wherein the motor is a stepper motor.

19. The projecting system of claim 15, wherein the first request signal is generated in response to the power-on of the projecting system.

20. The projecting system of claim 15, wherein the first request signal is generated in response to a first input command.

21. The lifting apparatus of claim 15, further comprising a detecting device for detecting, responsive to a second request signal, the height of the housing relative to the plane, generating a second height datum associated with the projecting system in accordance with the detected height, and storing the second height datum into the storing device.

22. The lifting apparatus of claim 21, wherein the second request signal is generated in response to the power-off of the projecting system.

23. The lifting apparatus of claim 21, wherein the second request signal is generated in response to a second input command.
